(19) United States
(12) Patent Application Publication
(10) Pub. No.: US 2005/0184216 A1
(43) Pub. Date: Aug. 25, 2005

(54) Front-mounted removable mold insert for injection molded hooks

(75) Inventors: Henry J. McVicker, Naples, FL (US); Joe Darrell Hutto, Fort Meyers, FL (US)

Correspondence Address: JONES DAY, 77 WEST WACKER, CHICAGO, IL, 60601-1692, US

(73) Assignee: Inter-Mold Corporation, Naples, FL (US)

(21) Appl. No.: 10/786,436

(22) Filed: Feb. 25, 2004

(51) Int. Cl. B29C 33/12

(52) U.S. Cl. 249/102; 425/195

(57) ABSTRACT

A mold insert is mountable on an inner surface of a mold cavity, the mold insert having a molding surface that is a complement of a desired molded structural feature. The mold insert is easily removed from the mold by accessing the front, inner surface of the mold cavity, to facilitate repair, replacement, or exchange of the mold insert.

This invention relates to a mold having a removable mold insert, and to the mold insert itself, wherein the mold insert and the mold are used for injection molding an article having a field of integrally molded hooks. This invention further relates to such a mold and mold insert wherein the mold insert is mountable on a front or inner surface of the mold.

An injection molded article having a field of hooks formed integrally on a surface thereof and a method and apparatus for making such an article are disclosed in U.S. Pat. Nos. 5,656,226 and RE 37,338, the disclosures of which are incorporated herein by reference in their entireties. As disclosed in these references, an injection molded article has a field of injection molded hooks integrally formed on a predetermined area thereof on at least one wall during the injection molding process, the field of hooks capable of releasable attachment to a cooperative loop-bearing member. The hooks have reduced radius compared to prior art hooks and a changed geometry for promoting ejection from the mold during the injection molding process, yet still maintain the desired fastening function. The thermoplastic material used to mold the hooks has a memory sufficient to cause the hooks to return substantially to their original position after being removed from the mold, and yet has sufficient flexibility to allow the hooks to bend during removal from the mold and during engagement and release from the cooperative loop-bearing member.

As further disclosed in the references, an apparatus for making such an injection molded article can comprise a mold block having two sections that join together to define a cavity having the shape of the injection molded article. A recess is formed in the mold block for receiving an insert, the insert comprising plates each having hook-shaped cavities formed in an edge thereof, such that when the plates are placed in stacked relation their edges define a field of hook shaped cavities, the plate edges defining one surface of the mold insert that can e substantially contiguous with the inner surface of a section of the mold block. The plates having the hook-shaped cavities can be alternated with spacer plates having no cavities to define a field of spaced rows of hooks formed on a surface of the molded article.

In the embodiment illustrated in the references, the injection molded device is an orthopedic ankle brace, and in particular one of the shells of the brace that are disposed on either side of a patient's ankle. The field of hooks is formed on an outer surface of the shell. As illustrated in FIG. 10 of the references, a mold block for injection molding the ankle brace shell is in two sections, each of which has one half of the shape of the ankle brace shell. A series of plates having hook-shaped cavities formed in the edges thereof are positioned in stacked relation in a recess in one of the mold sections. The blocks are brought together in liquid-tight relationship in a well-known manner and the liquid plastic is injected into the cavity formed by the sections under pressure through an orifice to fill every portion of the cavity, including the hook areas in the plate edges. When the plastic is set into its final shape, the mold sections are separated and the article is removed from the mold. The hooks may temporarily straighten as the article is removed from the mold and the hooks are pulled from the hook-shaped cavities, but the hooks almost immediately return to substantially their original shape.

U.S. Pat. No. 6,224,364, assigned to Velcro Industries, B.V. discloses an injection molded product having an array of fastener elements integrally molded with the product, the product being molded in a closed cavity die, at least one of the parts of the die having a movable segment constructed to be retracted across the mold cavity, such that the fastener element cavities and the mold cavity can be filled under different filling conditions and molded under different conditions.

It is desirable to be able to remove the insert having the hook-shaped cavities from the mold section, such a to be able to substitute one insert for another, or to replace or repair a mold insert that has somehow become damaged. In some situations, however, it may not be possible or practical to withdraw a mold insert from the back of the mold, as is standard industry practice. Such situations can arise, for example, when a very large part is being molded, and the rear surface of the mold section is not readily accessible to workers in the factory. It may be necessary to remove the mold from the processing machine, which can be a difficult operation. Especially where large molds are involved, the steps of stopping the production line, removing the mold, replacing the insert, re-installing the mold, and resuming operation of the production line can take as long as a full day. This down time can be unacceptable in many manufacturing situations.

It is thus one object of the invention to provide a mold and a mold insert for use with the mold wherein the mold insert can be removed from the mold other than by access to the back surface of the mold.

It is yet another object of the invention to provide a mold and a mold insert for use with the mold wherein the mold insert can be removed from the mold other than by access to the back surface of the mold, and wherein the mold insert comprises a plurality of hook shape cavities for use in forming a field of injection molded hooks on an injection molded article.

### SUMMARY OF THE INVENTION

In accordance with the invention, a mold insert is disclosed for use in providing a structural feature on the surface of a molded article, the mold insert being provided with means for mounting on the inner surface of a mold cavity. The mold insert comprises a molding surface having formed therein a structure that is the complement of the desired molded structural feature. The molding surface of the insert generally will be flush with the inner surface of the mold cavity when the insert is mounted to the cavity. The means for mounting the insert can comprise one or more projections extending from the insert in a plane substantially parallel to the insert molding surface, the projections encompassing fastening means. The invention further encompasses a mold such as for use in an injection molding machine, the mold having an orifice for receiving said insert, the mold cavity having an inner surface, the inner surface having means for receiving the projections on the mold insert. In a preferred embodiment, the receiving means are in the form of depressions of complementary size and shape to the projections on the mold insert, said depressions receiving said projections such that the molding surface of the mold insert is flush with the inner surface of the mold cavity. In a most preferred embodiment, the molding surface of the mold insert is provided with a plurality of hook-shaped cavities such that the molded article will have a field of injection molded hooks formed on a surface thereof.

### DESCRIPTION OF THE FIGURES

The present invention may be more readily understood by reference to the figures, wherein

FIG. 1 illustrates a mold insert of the invention, and a section of a mold defining a mold cavity having an inner surface adapted to receive the mold insert;

FIG. 2 illustrates an embodiment in which caps are used to cover the screws that hold the mold insert within the mold;

FIG. 3 is an enlarged view of the screw cap;

FIG. 4 is an exploded view of an alternative embodiment of a mold insert of the invention; and

FIG. 5 is a side cross-section view of the embodiment of FIG. 4.

### DETAILED DESCRIPTION OF THE INVENTION

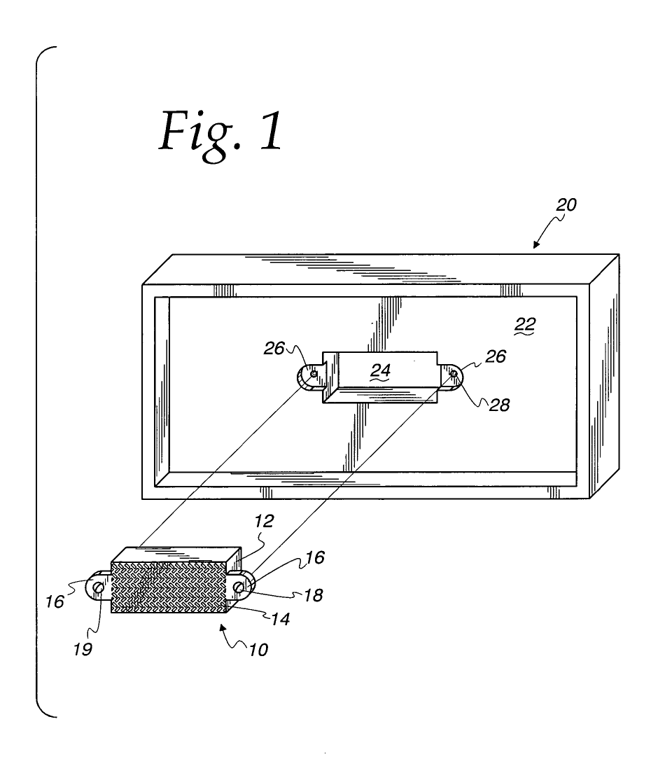

As illustrated in FIG. 1, mold insert 10 comprises a molding surface 12 having formed therein a structure that is the complement of a desired molded structural feature. In the illustrated embodiment, the desired molded structural feature is a field of injection molded hooks, and the surface 12 is provided with a plurality of hook-shaped cavities 14 that are the complement of the desired molded hooks. In the illustrated embodiment, the hooks are in rows with adjacent rows of hooks facing in opposite directions; other arrangements of hooks are possible.

FIG. 1 further illustrates one section 20 of a mold defining a mold cavity having an inner surface 22 provided with a cavity 24 sized and dimensioned to receive mold insert 10 when insert 10 is mounted in cavity 24, molding surface 12 of insert 10 will be substantially flush with inner surface 22 of mold cavity section 20. Another section of the mold, not shown, will fit against mold section 20 in cooperative relation to define a mold cavity, into which molten plastic can be injected to form an injection molded article, as is known in the art.

Mold insert 10 comprises means for mounting on surface 22 of mold section 20. In the illustrated embodiment, one or more projections 16 extending from the insert 10 in a plane substantially parallel to the insert molding surface 12, the projections further encompassing fastening means for fastening the projections to inner surface 22. Inner surface 22 of mold section 20 is provided with means for receiving insert mounting means. In the illustrated embodiment the receiving means are in the form of one or more depressions 26 sized and dimensioned to receive the projections 16 of insert 10. Preferably, depressions 26 receive said projections 16 such that the molding surface 12 of the mold insert 10 is flush with the inner surface 22 of the mold cavity section 20. Projections 16 are provided with apertures 18 and depressions 26 are provided with apertures 28, the apertures 18 and 28 being in alignment when mold insert 10 is mounted in orifice 24. Apertures 18 and 28 can receive a fastening means such as a flat-head screw 19 or other mechanical fastening device that serves to secure insert 10 to mold section 20.

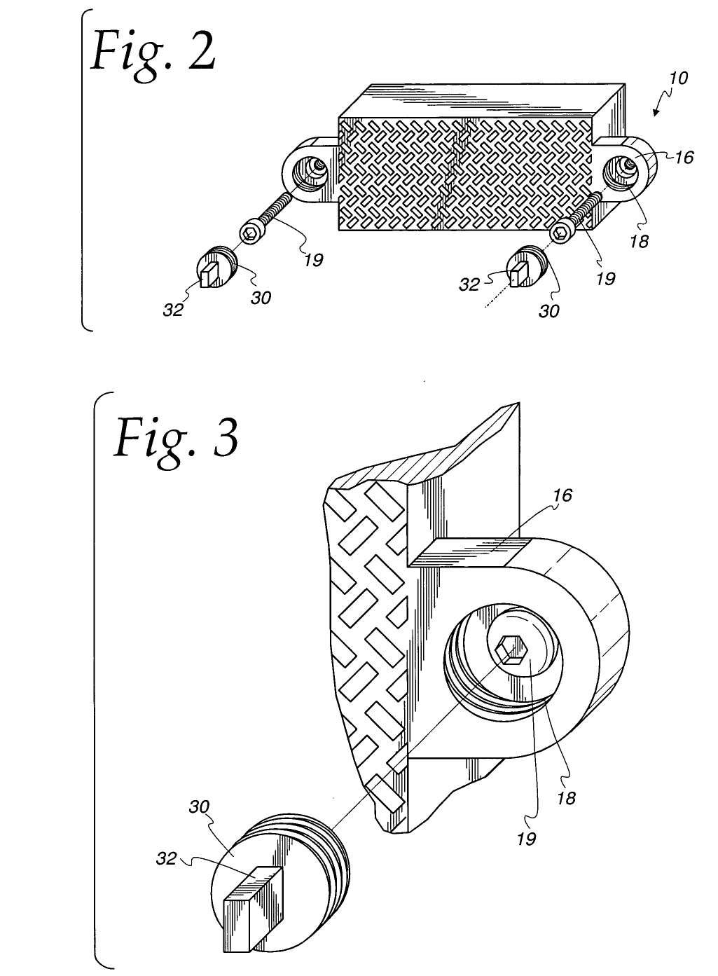

In the embodiment illustrated in FIG. 1, the top surface of fastening means 19 might leave an impression on the finished molded article. In cases where this is considered undesirable, the embodiment shown in FIGS. 2 and 3 can be used. This embodiment is similar to that shown in FIG. 1, except that the aperture 18 is deeper such that the head of fastening means 19 is recessed when it is used to mount insert 10 in mold section 20. This recess can be filled with a cap 30. Cap 30 preferably is provided with an appendage 32 on its outer end. Appendage 32 is used to position cap 30 within aperture 18 of mold insert 10. Appendage 32 can then be machined away to provide a smooth surface on cap 30, to provide a corresponding smooth surface on the article molded in mold section 20. If it is desired to remove mold insert 10 for any reason, then cap 30 can be drilled out to expose fastening means 19.

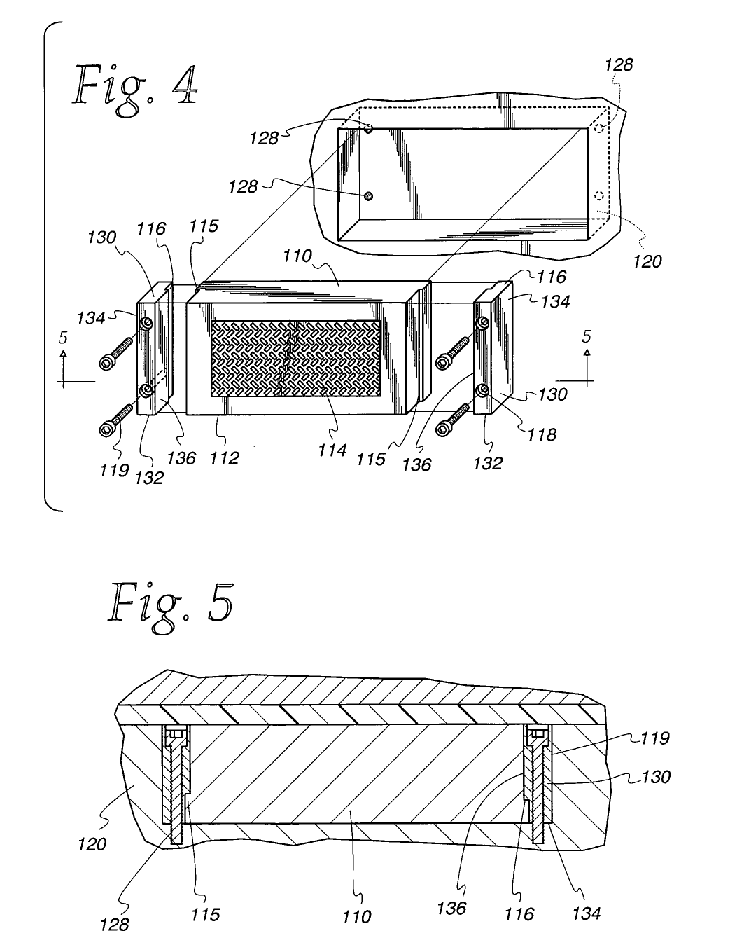

An alternative way of attaching a mold insert to a section of a mold is illustrated in FIGS. 4 and 5. As illustrated therein, a mold section 120 is provided with a plurality of apertures 128. Mold insert 110 has a surface 112 that includes structures that are a complement of the desired molded structural feature. Shoulders 115 are disposed on opposite sides of mold insert 110, and adjacent the rear surface thereof that fits against mold section 120. Retaining means in the form of retaining blocks 130 are provided, each having a front wall 132, a rear wall 134, and a side wall 136 that is disposed against a side of mold insert 110. Rear surface 134 includes a channel 116 that fits cooperatively against a retaining surface such as shoulder 115. Apertures 118 extend through the front surface 132 and rear surface 134 of retaining blocks 130. Fastening means 119 extend through apertures 118 and corresponding apertures 128 in mold section 120. Caps may be provide over the ends of fastening means 119, as discussed above in relation to FIGS. 2 and 3.

The advantage of the embodiment of FIGS. 4 and 5 is that mold section 120 does not need to be adapted to engage mold insert 10, other than by providing apertures for receiving fastening elements. It is not necessary, for example, to provide depressions 26 for receiving projections on a mold insert. This may be particularly desirable when adapting a pre-existing mold to receive a mold insert of the present invention.

It may be seen that the present invention allows a mold insert to be readily removed from a mold section, even when the back surface of the mold section is not readily accessible, and without removing the mold from the production line. This allows for the use of interchangeable mold inserts to allow for the manufacture of molded articles having different structural features on their molded surfaces. For example different fields of hooks may be used for articles that will have different applications, or it may be desirable to produce some articles with a smooth surface and no hooks. Also, an insert that becomes damaged or broken can be replaced quickly and easily. A manufacturer can maintain an inventory of a variety of inserts, different hook patterns, for quick repair of the production line or adaptation of the line for the manufacture of different parts.

The foregoing description of a preferred embodiment of the instant invention is intended by way of example and not by way of limitation. Other modifications and equivalents will be readily understood by those skilled in the art. It is expected that others skilled in the art will perceive other variations which, while different from the foregoing, do not depart from the scope of the invention described herein. In particular, any of the specific constructional elements described may be substituted of any other known element having equivalent function.

1. An insert for use as a mold component in the manufacture of a molded article, the molded article having a structural feature on a surface thereof, the insert being sized and dimensioned to fit within a recess in the mold, the insert comprising
a first surface having an area thereon that is a complement of the structural feature on the molded article, and
means for mounting said insert in said recess on an inner surface of said mold.

2. The insert of claim 1 wherein said mounting means comprises one or more projections adapted to fit within corresponding depressions in the inner surface of the mold cavity.

3. The insert of claim 2 wherein said one or more projections comprise apertures for receiving means for fastening said mold insert to said mold.

4. The insert of claim 3 wherein said apertures in said one or more projections comprise a recessed region for receiving an end of said fastening means, such that the end of said fastening means is recessed with respect to the front surface of said projections when said insert is fastened to the inner surface of the mold.

5. The insert of claim 4 wherein further means for providing a substantially smooth surface over said recessed region of said aperture.

6. The insert of claim 5 wherein said means for providing a substantially smooth surface comprises a cap that fits within said aperture in front of the end of the fastening means.

7. The insert of claim 6 wherein said cap comprises a removal appendage or the front surface thereof.

8. The insert of claim 1 wherein said mounting means comprises one or more retaining surfaces, said insert further comprising one or more retaining means that engage said one ore more retaining surfaces.

9. The insert of claim 8 wherein said one or more retaining surfaces comprises a shoulder extending from a side of said mold insert, and said one or more retaining means comprises a retaining block having a surface that engages said shoulder.

10. The insert of claim 9 wherein said retaining block comprises one or more apertures for receiving a means for fastening said retaining block to said mold.

11. A mold for use in the manufacture of a molded article, said mold having an inner surface defining a cavity in which said molded article is formed, said inner surface having a recess adapted for receiving a mold insert.

12. The mold of claim 11 further comprising means on said inner surface of said mold cavity for receiving means for mounting said insert thereto.

13. The mold of claim 12 wherein the mounting means comprises one or more projections extending from the mold insert, and said receiving means comprises one or more depressions in said inner surface of said mold cavity, said depressions adapted to receive said projections.

14. A mold insert for use in a mold for molding an article having a structural feature on its surface, the mold having an inner surface that defines a cavity in which said molded article is formed, said inner surface having a recess therein, said mold insert being sized and dimensioned to fit within said recess, said mold insert having a first surface for forming said structural feature on the surface of the molded article, said mold insert comprising means for mounting said insert on said inner surface of said mold.

15. The mold insert of claim 14 wherein said mounting means comprises one or more projections extending from said mold insert and adapted to be received within one or more corresponding depressions in the inner surface of said mold.

16. The mold insert of claim 15 wherein said one or more projections comprise means for receiving a fastening means.

17. The mold insert of claim 16 wherein said means for receiving a fastening means is one or more apertures.

18. The mold insert of claim 14 wherein said first surface of said mold insert is substantially contiguous with the inner surface of the mold when the insert is mounted on said inner surface of the mold.

19. The mold insert of claim 14 wherein said first surface for forming said structural feature comprises a plurality of hook-shaped cavities, said plurality of hook-shaped cavities forming a field of integrally molded hooks on a surface of the molded article.

20. The mold insert of claim 19 wherein said mold insert comprises a plurality of plates, each plate having a side edge, said plates being stacked together, with said side edges defining at least a portion of said first surface of said mold insert, said hook-shaped cavities being formed in said side edges.

21. The mold insert of claim 20 further including one or more spacer plates positioned between said hook-cavity plates, such that said field of integrally molded hooks on a surface of the molded article will be an array of spaced rows of hooks.
